(19) United States
(12) Patent Application Publication
(10) Pub. No.: US 2008/0029125 A1
(43) Pub. Date: Feb. 7, 2008

(54) Method and apparatus for damage-free, single wafer, sonic boundary layer, megasonic cleaning

(75) Inventors: Michael B. Olesen, Brentwood, CA (US); Kenneth C. Struven, San Carlos, CA (US); Paul Mendes, Morgan Hill, CA (US)

Correspondence Address: ZIMMERMAN & CRONEN, LLP, 1330 BROADWAY, SUITE 710, OAKLAND, CA, 94612-2506, US

(73) Assignee: IMTEC ACCULINE, INC.

(21) Appl. No.: 11/888,598

(22) Filed: Jul. 31, 2007

Related U.S. Application Data
(60) Provisional application No. 60/835,255, filed on Aug. 2, 2006.

(51) Int. Cl. B08B 3/12

(52) U.S. Cl. 134/1.3; 134/184

(57) ABSTRACT

A method and apparatus for megasonic cleaning of semiconductor wafers. The wafer is positioned so that the surface to be cleansed is parallel to and faces the radiating surface of a quartz or similar resonator which receives sonic waves through a liquid medium from a transducer. The sonic waves striking the wafer are preferably at about a 5° to 30° offset angle from a normally directed wave to the plane of the wafer. The layered medium is gasified and serves to couple the transducer to the resonator. A layer of degasified cleaning fluid is positioned between the resonator and the wafer.

### CROSS-REFERENCE TO RELATED APPLICATIONS

This application is based on Provisional Application No. 60/835,255, filed Aug. 2, 2006, by the same inventors listed herein, and claims priority as to the common subject matter in the respective applications.

### FEDERALLY FUNDED RESEARCH

Not applicable.

### SEQUENCE LISTING, ETC. ON CD

Not applicable.

### BACKGROUND OF THE INVENTION

1. Field of the Invention

This invention generally relates to the megasonic cleaning of semiconductor wafers or the like; and more particularly to a method and apparatus for cleaning the surface of such a wafer while eliminating, or at least substantially reducing, sonic induced damage to the wafer.

### DESCRIPTION OF RELATED ART

In connection with the production of semiconductor wafers, it is necessary to thoroughly clean the substrate in order to remove particulates, predeposited layers or strip resist, or other contamination.

One well known process utilizes ultrasonic cleaning, i.e., the application of high amplitude ultrasonic energy to the substrate in a liquid bath. When the ultrasonic energy is in the range of about 0.60 to 10.00 MHZ, the process is termed megasonic cleaning. In broad terms, megasonic cleaning typically involves immersing the substrate in a tank filled with one of several well known liquid baths, immersing a megasonic transducer in proximity to the substrate with the acoustic output of the transducer being coupled to the surface or surfaces of the substrate by the liquid bath solution. Such liquid bath solutions may, for example, comprise deionized water, standard cleaning solutions, dilute NH₄ OH:H₂0₂, or the like.

In connection with megasonic cleaning as described above, in one or more prior applications for patent assigned to the assignee of the present application, it has been suggested that the use of an oblique angle about 5° to 30° of megasonic energy impingement to a substrate surface can eliminate structural damage while allowing for adequate cleaning on sub64 nm semiconductor wafers. It has been further suggested that the oblique angle can be accomplished by either refraction of the sound waves through a resonator whose surface completely covers the wafer being cleaned, or by direct application of the sonic waves through a resonator whose surface completely covers the wafer being cleaned, or by direct application of the sonic waves from a relatively small transducer head positioned above the substrate at an oblique angle. It has been suggested that the use of higher frequency sonic waves, such as 2 MHz and greater, can reduce sonic induced damage by reducing the size of cavitation bubbles which reduces the strength of the sonic shock waves. The new invention has similar attributes, but its method and apparatus present an improvement in performance as compared to the prior alternatives.

### BRIEF SUMMARY OF THE INVENTION

The present invention utilizes the features above set forth for megasonic cleaning the front, backside and/or edge of a semiconductor wafer, in which such wafer surface is positioned in close proximity to a sonic resonating assembly in which the wafer is uniformly exposed to the megasonic energy and the cleaning solution of the liquid bath. Both front and backside, as well as edge cleaning is accomplished when liquid is exposed to such surfaces in the presence of a sonic wave. As will also be made clear, the wafer is generally held so that the surface to be cleaned is parallel to and faces the radiating surface of the megasonic resonator whether the resonator is positioned above or below the wafer in the liquid bath.

### BRIEF DESCRIPTION OF THE DRAWINGS

FIG. 1 is a cross-sectional elevational view of a portion of a wafer cleaning tank showing the relative positions of the transducer, resonator and wafer (positioned above the resonator). This figure also diagrammatically illustrates the direction of the sonic waves.

FIG. 2 is a view similar to FIG. 1, but illustrating a second embodiment of the invention including exterior walls between the transducer and the resonator plate.

FIG. 3 is a view similar to FIG. 2, except that the transducer is positioned non-parallel to the wafer.

FIG. 4 is a top plan view illustrating the position of the transducer assembly of FIG. 1 or FIG. 2, but with the transducer disposed above the wafer. This figure also diagrammatically illustrates the decaying sonic wave path as it moves within the resonator away from the emitting source.

FIG. 5 is a cross-sectional elevational view of the structure shown in FIG. 4.

FIG. 6 is a diagrammatic top view illustrating wafer rotation and nature of transducer movement.

FIG. 7 is a plan view diagrammatically illustrating a full plate embodiment of the invention with a piezo transducer array and the positioning of external blanket heaters to assist in thermal control.

### DETAILED DESCRIPTION OF THE INVENTION

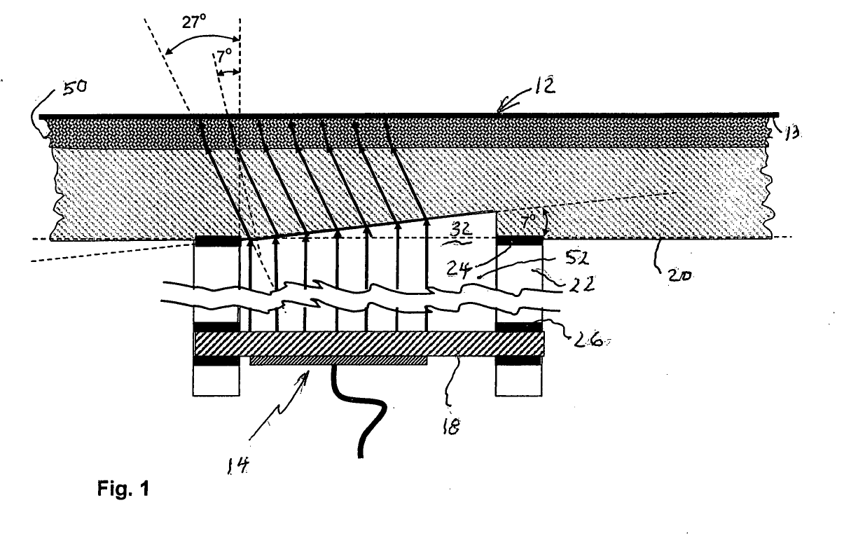

The method and apparatus of the present invention is best illustrated and explained by reference to the accompanying drawings. It has already been explained that the purpose of this invention is to provide a damage-free megasonic cleaning of semiconductor wafers. In accordance with this invention, as shown in FIG. 1, a wafer 12 is showing having a front surface 13 which is to be cleaned. However, as discussed above, the opposed surface, as well as the wafer edges are also subject to cleaning. In FIG. 1, the wafer is illustrated above and parallel to a transducer assembly 14 which includes a generally planar piezo mounted on and depending from a stainless steel plate 18 positioned below and spaced from a resonator plate 20, preferably formed of quartz.

Extension walls 22 formed of PFA, aluminum, or the like extend generally normal to the transducer 14, mounting plate 18 and resonator plate 20, with appropriate seals 24 and 26 sealing the wall 22 to the resonator plate and the transducer mounting plate respectively. The cross-sectional area defined by the wall 22 is less than the surface 13 of the wafer, but rotation of the wafer and/or reciprocating lateral movement of the transducer and resonator assures all portions of such surface will be exposed to the sonic energy transmitted to such surface.

The lower surface of resonator plate 20 and extending for the diameter of the wall 22 has a wedge-shaped cut-away portion defining an angle of about 6° to 8° relative to the plane of wafer 12. This is indicated in the drawings as 7°, which is believed the optimum, but slight variations are also believed to be appropriate. This cut-away portion defines a cavity 32 in the lower surface of the resonator plate 20. It is understood that all of the parts described above are positioned in a tank (not shown) filled with the cleaning liquid above described. Gasified cleaning liquid is disposed as a layer 50 between the lower surface 13 of wafer 12 and the upper surface of the resonator plate 20. Degasified coupling liquid 52 is disposed within the chamber defined by the transducer plate 18, the walls 22 and cavity 32.

Using the foregoing arrangement, the cleaning of the wafer utilizes at least one acoustic transducer 14 positioned to cover and seal cavity 32 in resonator plate 20 and transmit sonic energy through a liquid boundary layer contained in the cavity into the resonator plate. The resonator plate has at least one obliquely angled surface, wetted by said liquid and conducts sonic wave energy through the plate to emerge from the opposing planar surface of said plate and impinges at any oblique angle from about 5° to 30° to the surface of the substrate 12 being cleaned.

The primary attribute of this invention is the use of a liquid boundary layer to acoustically couple the megasonic energy of the piezo electric device, transducer 14 to the sonic resonating assembly plate 20 in such manner that the energy emerges from the opposite surface of the plate at an off-normal angle advantageous to the cleaning of the surface of an opposing wafer's surface 13 without damage thereto. The transducer is coupled acoustically to the plate through a degasified liquid boundary layer, through the plate to the opposite side which, in turn, acoustically couples to the wafer through a gasified cleaning fluid. At least one megasonic transducer is secured to the resonator assembly, which is tuned, in terms of mass, size and thickness for a given frequency, to pass the sonic energy of the transducer. The resonator assembly is so shaped as to accept the transducer's acoustic signal at the transducer-to-resonator assembly mounting surface and bend it at the resonator plate's planar-to-wafer distal surface so that the sonic signal exits at an optimal angle off-normal to the surface of the wafer while the resonator plate's facing surface remains parallel thereto. Those versed in the art will recognize that the angle of mounting of the transducer to the resonator plate, given a desired off-normal angle of exit, is determined by the materials of construction of the transducer, the resonator assembly, the bonding materials between the two faying surfaces, the sonic density of the fluid interface and the wavelength of the sonic signal as the physical phenomena reasonably follow Snell's Law and refraction. The following equation describes this phenomenon per Snell's Law:

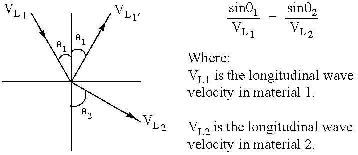

It is believed that an approximate 6° to 8°, and preferably 7° angle of incidence of sonic energy to the surface of the wafer is optimal for cleaning particulate from the surface of the wafer while avoiding inducing damage thereto. Other angles between 5° to 30° have been tested and shown to work, however with less cleaning efficiency. A range of suitable materials may be used for the resonator assembly depending in part upon wafer processing materials compatibility. One such suitable material frequently chosen for its purity in semiconductor wafer processing is quartz. Using quartz, as shown in FIG. 1, with an acoustically coupled liquid boundary layer of degasified water having an approximate impingement angle of 7° off-normal to the first surface of the quartz will create a refracted angle within the quartz of approximately 27°, which is convenient to produce the desired 7° off-normal emission angle in water as it exits the plate and continues on through the gasified cleaning fluid to strike the wafer.

The mounted transducer-to-resonator angle of about 6° to 8°, and preferably about 7° would be the same for other suitable sonic refracting materials, such as stainless steel, aluminum, silicon carbide coated graphite, etc. However, the internal refraction angle within the material would vary as a result of the velocity of sound for the given material to achieve the desired 7° optimum emission angle in the cleaning fluid 50.

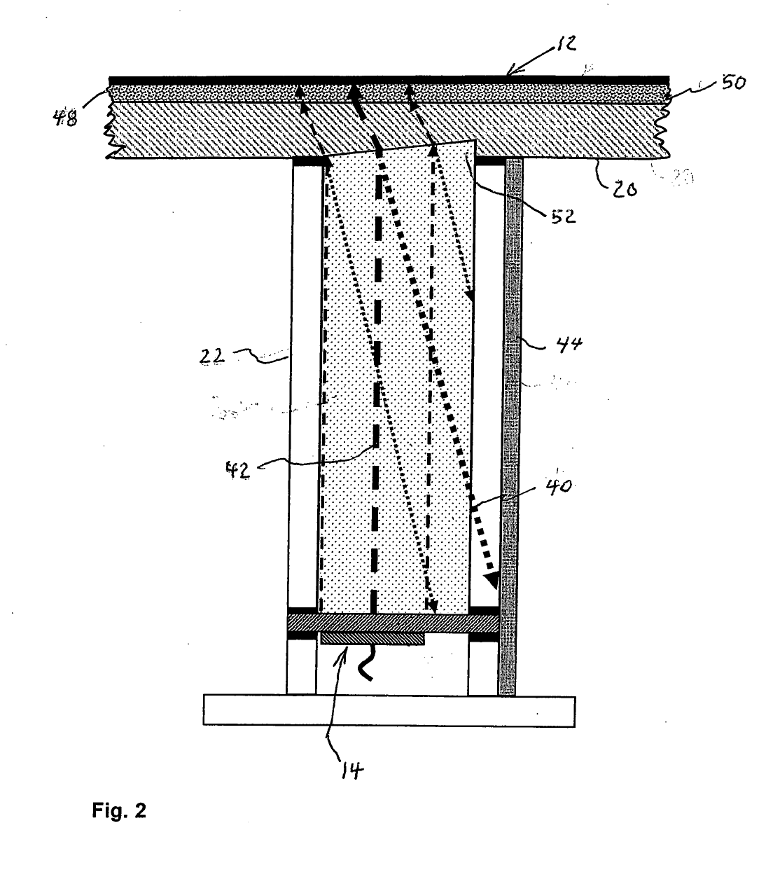

FIG. 2 illustrates a slightly modified arrangement in which the transducer is spaced from the quartz resonator plate 20 by PFA Teflon or aluminum extension walls 22. These walls are designed to eliminate reflected waves 40 from interfering with the frequency waves 42 emitted from the transducer 14. Here, an acoustically damping tungsten carbide or similar epoxy 44 is applied to walls 22 to eliminate sonic reflections from the walls going back to the transducer. The degasified liquid boundary is indicated at 52 and the gasified cleaning liquid at 50.

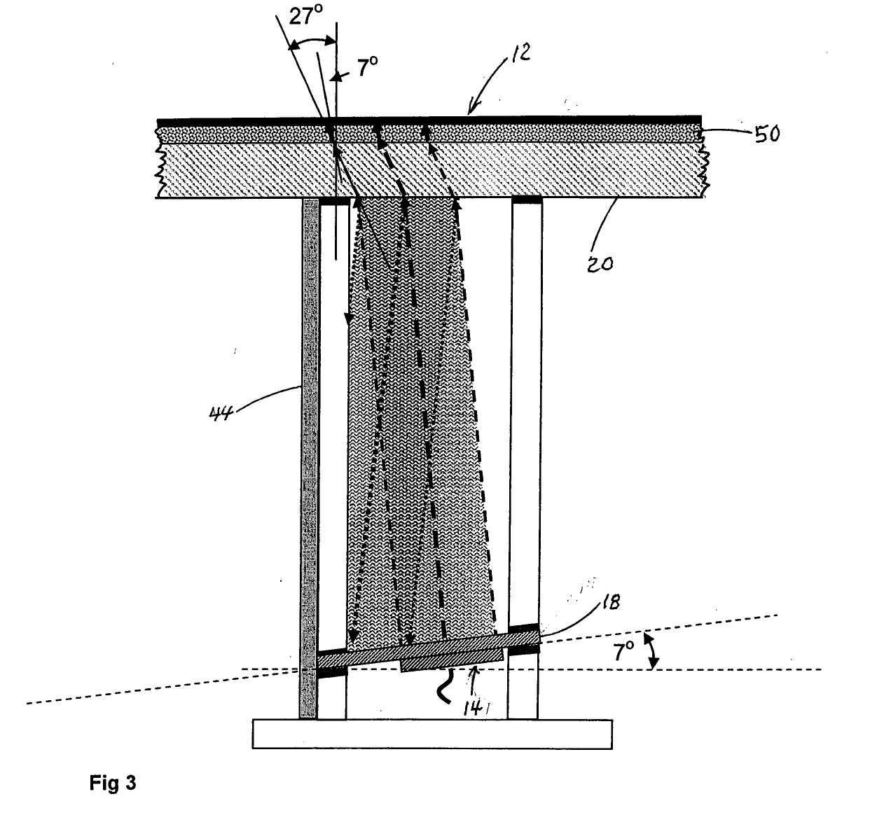

With reference to FIG. 3, it is noted that the transducer 14 and its mounting plate 18 are disposed at about a 6° to 8° offset angle from the horizontal and from the plane of wafer 12. The resonator plate 20, however, has parallel upper and lower surfaces and does not have the cut-out portion 32. A 7° angle is believed to give the best results. The sonic effect on the lower surface of the wafer will accordingly remain the same as that illustrated in FIGS. 1 and 2 of the drawings.

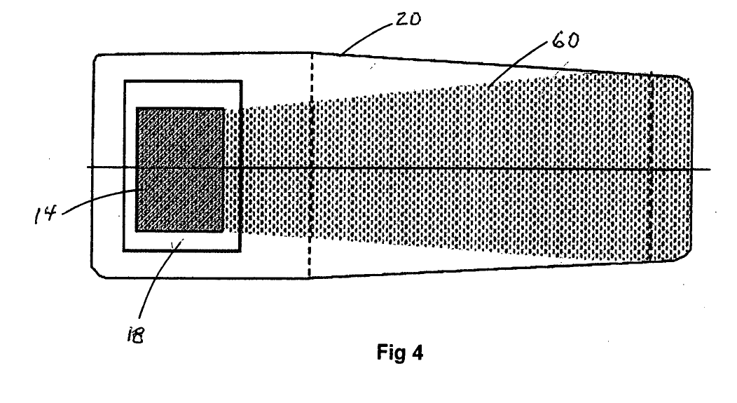

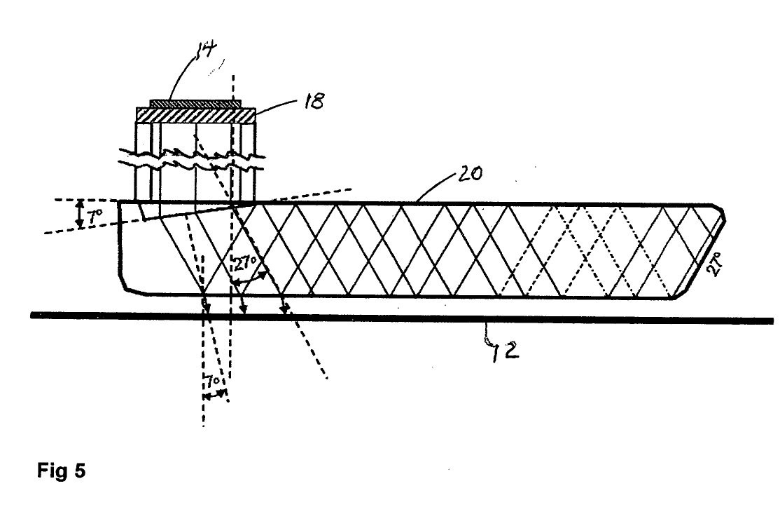

FIGS. 4 and 5 represent the transducer 14 disposed above the wafer 12 and diagrammatically illustrates the sonic path 60 as it moves within the quartz resonator 20 and away from the transducer 14. The energy dissipates as it moves from left to right as illustrated in the drawing.

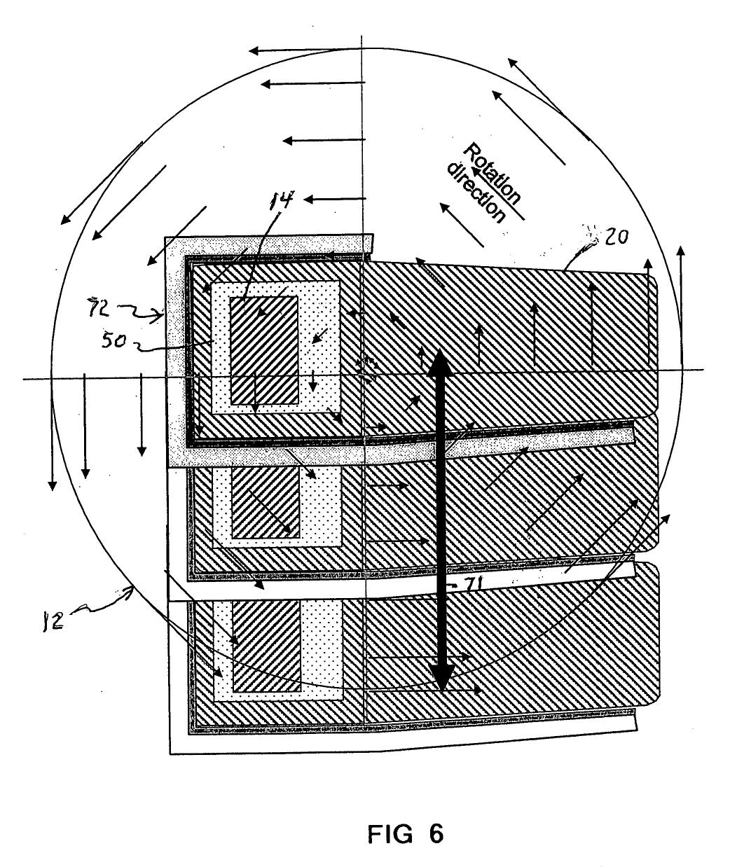

In FIG. 6, rotation of the wafer 12 is shown, along with the linear movement 71 of transducer 14. The degassed boundary layer 50 is also indicated, along with a manifold 72 for gasified liquid distribution.

The foregoing description is not an attempt to explain or illustrate all possible modifications or variations of the present invention, but rather to illustrate that the plane of the radiating surface of the refracting resonator plate 20 is disposed parallel to the confronting surface of the wafer 12, thereby comprising the uniformity of the resulting oblique angle sonic wave bounce that occurs.

The invention also lends itself to temperature control of a boundary layer fluid so as to permit control of the transducer temperature, particularly during the exothermic active-megasonic cycle. This thermal control of the transducer both protects and extends the life of the transducer and permits higher temperature wafer processes up to about 95° C.

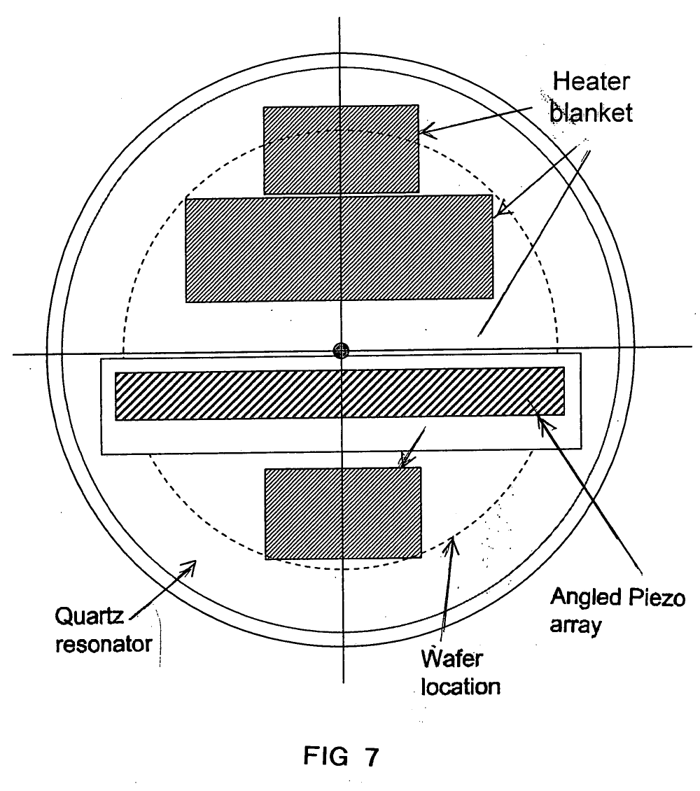

If additional heat is required by the process, it is easy to heat the plate 20 by external blanket heaters mounted to the back surface of the quartz resonator as has been disclosed in a prior application owned by the assignee of this invention, and shown in FIG. 7 of the drawings.

The sonic resonator plate assembly can be much thinner than the previously suggested 30° angle direct bonded approach. This reduces cost and allows for faster heating when a heated assembly is required (especially when quartz is used).

The manufacturing of the boundary-layer-based assembly is much simpler and less costly to produce. The piezo crystals are mounted to standard plate materials to form the transducer assembly, which in turn is mounted to the resonator plate by means that permit its rapid removal, rather than less expedient, more costly, and lower dependable method of directly bonding the piezo to large, relatively exotic, unwieldy structures.

Other features of the present invention are set forth below.

Replacement of the transducer subassembly on the resonator plate without destruction of the entire assembly becomes possible with a boundary-coupled transducer, as compared to the directly bonded techniques more usually used.

The liquid coupling of the sonic energy from transducer to resonator plate is typically far more accepting of a range of sonic frequencies than are solid transducer-to-plate interfaces. This at least provides the opportunity for future in situ swap-outs to different frequency transducers (with associated changes in emission angles corresponding to the rules of Snell's Law).

The design allows the sonic resonator assembly to be mounted facing the front surface of the wafer from above or below.

This invention can incorporate a full surface resonator plate, of a size larger than that of the wafer, thereby completely covering the wafer surface as illustrated in FIG. 7, or it can be a smaller, above-the-wafer, head-type assembly, as shown in FIG. 5.

Relative to the latter, the transducer resonating plate 50 is supported on a translating mechanism (not illustrated herein) that enables the plate to be moved radially across and above the wafer. This radial motion can be accomplished by using a swinging action where the apparatus swings from the side to an over-center position above the wafer.

In another embodiment of the invention, the radial motion can be programmed for entrance rate, extension distance, and number of moves per cleaning cycle. This, across the wafer by normalizing the dwell time at any one point from center to edge of the wafer. Radial non-uniformity is a typical problem of most prior art rotating single wafer megasonic systems.

In yet another embodiment of the invention, the transducer assembly can include the distribution of its own cleaning and rinsing chemistries to impinge on the leading surface to the transducer yielding uniform and efficient distribution of fluids, especially with the movements disclosed in FIG. 6.

1. Apparatus for megasonic cleaning of a semiconductor wafer or the like, such wafer having a generally planar surface to be cleaned, comprising a generally planar resonator plate having a first outer surface adapted to be positioned parallel to and adjacent said wafer surface and a second outer surface; a transducer having a wave transmitting surface opposed to and spaced from said second outer surface of said resonator plate; at least a portion of said second surface of said resonator plate defining an acute angle with said transducer surface.

2. Apparatus as set forth in claim 1 in which said acute angle is approximately 5° to 30°.

3. Apparatus as set forth in claim 2 in which said acute angle is approximately 6° to 8°.

4. Apparatus as set forth in claim 1 in which said second outer surface of said resonator plate is angularly offset relative to the plane of said plate.

5. Apparatus as set forth in claim 4 in which said angular offset is approximately 6° to 8°.

6. Apparatus as set forth in claim 1 in which both surfaces of said resonator plate are substantially parallel and adapted to both be positioned parallel to said wafer, and said transducer surface is offset from the plane of said resonator plate.

7. Apparatus as set forth in claim 6 in which the angular offset is approximately 6° to 8°.

8. Apparatus as set forth in claim 1 further including a wall extending between said transducer and said resonator plate and defining therewith a chamber adapted to contain coupling liquid.

9. Apparatus as set forth in claim 1 including means adapted to contain a body of a degasified coupling fluid between said transducer and said resonator plate for transmitting sonic energy from said transducer to said resonator.

10. Apparatus as set forth in claim 9 including means adapted to contain a layer of gasified cleaning fluid between said transducer and said wafer.

11. A method for megasonic liquid bath cleaning of a semiconductor wafer comprising providing an acoustic transducer for transmitting sonic waves through a liquid coupling medium, a generally planar resonator receiving said waves in a direction generally normal to a surface of said transducer deposed adjacent and parallel to the plane of said wafer, causing said waves to engage said wafer at an acute angle offset from an axis normal to the plane of the wafer.

12. A method as set forth in claim 11 in which said angle is about 5° to 30°.

13. A method as set forth in claim 12 in which said angle is about 6° to 8°.

14. A method as set forth in claim 11 in which said resonator is formed of one of quartz, stainless steel, aluminum, silicon carbide, or coated graphite.

15. A method as set forth in claim 11 in which said sonic waves engage and pass through said resonator at an angle of about 27° from an axis normal to plane of said wafer.

16. A method as set forth in claim 11 in which a layer of cleaning fluid is disposed between said resonator and said wafer.

17. A method as set forth in claim 11 in which cleaning fluid is positioned between said transducer and said transmitter.

18. A method set forth in claim 11 in which a layer of cleaning fluid is disposed between said plate and said wafer, and a body of coupling fluid is disposed between said transmitter and said resonator.

19. A method as set forth in claim 18 in which said layer of cleaning fluid is gasified and said body of coupling fluid is degasified.

20. A method as set forth in claim 18 in which the temperature of said cleaning fluid may be increased up to about 95° C.
